(19) United States
(12) Patent Application Publication
(10) Pub. No.: US 2014/0323185 A1
(43) Pub. Date: Oct. 30, 2014

(54) MOBILE TERMINAL AND METHOD OF MANUFACTURING A CASE INCLUDED IN THE MOBILE TERMINAL

(71) Applicant: LG ELECTRONICS INC., Seoul (KR)

(72) Inventors: Jaeeon LEE, Seoul (KR); Soonil KWON, Seoul (KR); Mingi JUNG, Seoul (KR); Soyeon PARK, Seoul (KR); Eunjung KIM, Seoul (KR)

(73) Assignee: LG ELECTRONICS INC., Seoul (KR)

(21) Appl. No.: 14/089,503

(22) Filed: Nov. 25, 2013

(30) Foreign Application Priority Data
Apr. 26, 2013 (KR) 10-2013-0046965

(51) Int. Cl. H04B 1/38

(52) U.S. Cl. CPC H04B 1/3888
USPC 455/575.8; 216/24

(57) ABSTRACT

Provided a mobile terminal including a case that provides an external appearance of the mobile terminal, in which the case includes a base that is formed of a synthetic resin material, a color layer including heat-sensitive foam material, which is arranged in such a manner to cover the base, to realize a background color, a reflection layer with brightness, which is arranged in such a manner to cover the color layer, multiple etch portions that are formed in such a manner that at least one or more of the multiple etch portions pierce through the reflection layer using laser etching; and a foam portion that is formed from the heat-sensitive foam material that foams due to heat generated at the time of the formation of the etch portions and thus retains a texture.

### CROSS-REFERENCE TO RELATED APPLICATION

Pursuant to 35 U.S.C. §119(a), this application claims the benefit of earlier filing date and right of priority to Korean Application No. 10-2013-0046965, filed on Apr. 26, 2013, the contents of which is incorporated by reference herein in its entirety.

### BACKGROUND OF THE DISCLOSURE

1. Field of the Disclosure

The present invention relates to a mobile terminal that includes a case.

2. Background of the Disclosure

A mobile terminal is a device that can be carried around and has one or more functions such as to perform voice and video call communications, inputting and outputting information, storing data, and the like.

As functions of the terminal become more diversified, the terminal can support more complicated functions such as capturing images or video, reproducing music or video files, playing games and receiving broadcast signals. By comprehensively and collectively implementing such functions, the mobile terminal may be embodied in the form of a multimedia player or a device.

Various attempts have been made to implement complicated functions in such a multimedia device by means of hardware or software.

In addition, the user of the mobile terminal tends to consider his/her mobile terminals as a personal possession that characterizes his/her individuality and so, there are demands for various design-reflected constructions. The design-reflected construction includes changes and improvements in construction that are made to improve an external appearance of the mobile terminal.

A case of the mobile terminal also is considered in terms of the design-reflected construction. In recent years, this consideration in terms of the changes and improvements in construction has initiated research effort into the case that has a texture, a three-dimensional effect, and various color grades. Accordingly, the case with the novel construction to meet the demand for various high-quality designs is under development.

### SUMMARY OF THE DISCLOSURE

Therefore, an aspect of the detailed description is to provide a mobile terminal that is equipped with a case that realizes various color grades, a texture, and a three-dimensional effect.

To achieve these and other advantages and in accordance with the purpose of this specification, as embodied and broadly described herein, there is provide a mobile terminal including a case that provides an external appearance of the mobile terminal, in which the case includes a base that is formed of a synthetic resin material, a color layer including heat-sensitive foam material, which is arranged in such a manner to cover the base, to realize a background color, a reflection layer with brightness, which is arranged in such a manner to cover the color layer, multiple etch portions that are formed in such a manner that at least one or more of the multiple etch portions pierce through the reflection layer using laser etching, and a foam portion that is formed from the heat-sensitive foam material that foams due to heat generated at the time of the formation of the etch portions and thus retains a texture.

In the mobile terminal, the heat-sensitive foam material may be formed with carbon dioxide being trapped within a urethane group material from which the color layer is formed. In the mobile terminal, the heat-sensitive foam material may be formed from an addition of water to the urethane group material.

In the mobile terminal, the heat-sensitive foam material may include a shell, formed of an elastically-transformable material and a gas that fills in the shell, and the heat-sensitive foam material may be configured such that the heat-sensitive foam material foams by an expansion of the gas due to the heat generated at the time of the formation of the etch portions.

In the mobile terminal, the reflection layer containing an oxide may be formed in order to endure the heat generated at the time of the formation of the etch portion. In the mobile terminal, the reflection layer may be formed from multi-depositions of a ceramic-based oxide.

In the mobile terminal, the reflection layer may be formed in such a manner that the reflection layer reacts to the heat generated at the time of etching and thus covers the foam portion.

In the mobile terminal, the case may further include a deposition layer that is formed from deposition of a metal material in such a manner as to cover the reflection layer, and in which the multiple etch portions are formed.

In the mobile terminal, at least one or more of the multiple etch portions may be formed in such a manner as to pierce through the deposition layer in order to expose the deposition layer and thus realize different color grades.

In the mobile terminal, the deposition layer may be formed using a physical vapor deposition (PVD) technique, a chemical vapor deposition (CVD) technique, or a smog-type non-conductive vacuum metallization (NCVM) technique.

The mobile terminal may further include a coating layer that is arranged in such a manner as to cover the reflection layer and provides an external appearance of the case.

In the mobile terminal, the coating layer may be an ultraviolet light cure layer or a heat cure urethane layer that is formed of a material that is ultraviolet light-cured or is heat-cured.

In the mobile terminal, the color layer may be formed of an ultraviolet light cure paint, and to prevent improper curing due to a pigment at the time of the emission of ultraviolet light, an additive containing at least one selected from the group consisting of aliphatic hydrocarbons, aromatic hydrocarbons and ketones may be added to the ultraviolet light cure paint, along with the pigment.

In the mobile terminal, the additive may be formed in such a manner as to improve distribution of the pigment and thus improve adhesion of the color layer to the base. In the mobile terminal, the additive may be formed in such a manner as to increase roughness of the color layer and thus improve the adhesion of the color layer to the base.

In the mobile terminal, the additive may be formed in such a manner that when the color layer is thoroughly cured, the additive evaporates.

In the mobile terminal, the foam portion may be formed into a specific pattern in the case.

The mobile terminal may further include a window portion that provides another external appearance of the mobile terminal, in which the window portion includes a glass, a ultraviolet light cure layer that is arranged in such a manner as to cover the glass and has a pattern portion that recesses in a specific shape into one surface of the ultraviolet light cure layer, a reflection right that is deposited on one surface of the ultraviolet light cure layer in such a manner as to cover the pattern portion and in such a manner as to reflect at least one part of incident light incident and thus enable the pattern portion to have a three-dimensional effect, a color layer that is formed in such a manner to cover the reflection layer and realizes a background color of the window portion, and a silane additive containing one selected from the group consisting of epoxy radical, alkoxysilyl radical, phenolic radical, and aromatic ring, that is formed in such a manner as to improve adhesion of the ultraviolet light cure layer to the glass.

In the mobile terminal, the silane additive may be added to the ultraviolet light cure layer or is added to an adhesion layer that is arranged between the window portion and the ultraviolet light cure layer.

To achieve these and other advantages and in accordance with the purpose of this specification, as embodied and broadly described herein, there is provided a method of manufacturing a case providing an external appearance of a mobile terminal, including forming a color layer including a heat-sensitive type foam material on a base that is formed of a synthetic resin material, forming a reflection layer with a predetermined thickness on the color layer, and etching the reflection layer in such a manner that the heat-sensitive type foam material foams due to heat generated at the time of the etching and thus retains a texture.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

FIG. 1 is a perspective diagram illustrating a mobile terminal according to one embodiment of the present invention when viewed from the front;

FIG. 2 is a perspective diagram illustrating the mobile terminal in FIG. 1 when viewed from rear;

FIG. 3 is a perspective exploded diagram illustrating the mobile terminal in FIG. 1;

FIG. 4 is a cross-sectional diagram illustrating an example of a battery cover illustrated in FIG. 3;

FIG. 5 is a diagram illustrating a process of forming a foam portion in a part A in FIG. 4;

FIG. 6 is a diagram illustrating the process of forming the foam portion in a part B in FIG. 4;

FIG. 7 is a cross-sectional diagram illustrating another example of the battery cover illustrated in FIG. 3;

FIG. 8 is a cross-sectional diagram illustrating an example of a window portion illustrated in FIG. 1;

FIG. 9 is a cross-sectional diagram illustrating the example of the window portion illustrated in FIG. 1; and

FIG. 10 is a diagram illustrating an example in which a construction of the window portion illustrated in FIG. 8 or FIG. 9 is realized in a battery cover.

### DETAILED DESCRIPTION OF THE DISCLOSURE

Hereinafter, a mobile terminal and a manufacturing method of a case included therein according to the present invention will be explained in more detail with reference to the accompanying drawings. For the sake of brief description with reference to the drawings, the same or equivalent components will be provided with the same reference numbers, and description thereof will not be repeated. A singular expression used in the specification includes a plural meaning unless it is distinctively disclosed. The suffixes attached to components, such as ‘module’ and ‘unit or portion’ were used for facilitation of the detailed description of the present invention. Therefore, the suffixes do not have different meanings from each other.

The mobile terminal according to the present invention may include a portable phone, a smart phone, a laptop computer, a digital broadcasting terminal, Personal Digital Assistants (PDA), Portable Multimedia Player (PMP), an E-book, a navigation system, etc.

However, it will be obvious to those skilled in the art that the present invention may be also applicable to a fixed terminal such as a digital TV and a desktop computer.

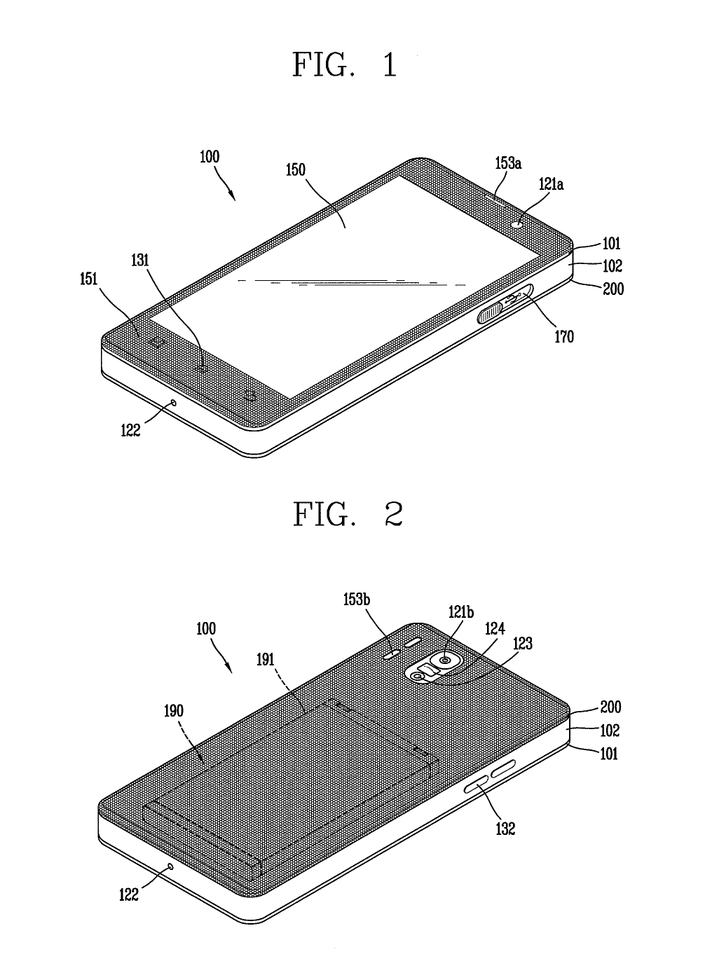

FIG. 1 is a front perspective view of a mobile terminal 100 according to the present invention.

Referring to FIG. 1, the mobile terminal 100 according to the present invention is a bar type mobile terminal. However, the present invention is not limited to this, but may be applied to a watch type, a clip type, a glasses type, a folder type in which two or more bodies are coupled to each other so as to perform a relative motion, a swing type, a swivel type, etc.

A case (casing, housing, cover, etc.) forming an appearance of a terminal body may include a front case 101 and a rear case 102. Various components may be accommodated in a space formed by the front case 101 and the rear case 102. At least one intermediate case may be additionally provided between the front case 101 and the rear case 102. And, a battery cover 200 configured to cover a battery 191 may be detachably mounted to the rear case 102.

Such cases may be formed by injection-molded synthetic resin, or may be formed using a metallic material such as stainless steel (STS), titanium (Ti) and aluminum (Al).

A display unit 150, a first audio output unit 153a, a first camera 121a, a first user input unit 131, etc. may be formed on the front surface of the terminal body. A microphone 122, an interface unit 170, a second user input unit 132, etc. may be formed on the side surface of the terminal body.

The display unit 150 is configured to display (output) information processed by the mobile terminal 100. The display unit 150 may include a liquid crystal display (LCD) module, a thin film transistor-liquid crystal display (TFT LCD), an organic light-emitting diode (OLED), a flexible display, a three-dimensional (3D) display and an e-ink display.

The display unit 150 may include a window portion 151. The window portion 151 is divided into an edge region (S) processed to be opaque, and a central region (C) enclosed by the edge region (S). The central region (C) may have an area corresponding to a display unit for outputting visual information.

The display unit 150 may include a touch sensing means for sensing content input in a touch manner. Once a region on the display unit 150 is touched, content corresponding to the touched region is input. Content input in a touch manner may be texts, or numbers, or menu items which can be instructed or set in each mode.

The touch sensing means may be formed to be transmissive so that the display unit 150 can be viewed, and may include a structure for enhancing visibility of the display unit 150 at a bright place. Referring to FIG. 1, the display unit 150 occupies most parts of the front surface of the front case 101.

The first audio output unit 153a and the first camera 121a are disposed at a region close to one end of the display unit 150, and the first user input unit 131 and the microphone 122 are disposed at a region close to another end of the display unit 150. The second user input unit 132 (refer to FIG. 2), an interface unit 170, etc. may be disposed on the side surface of the terminal body.

The first audio output unit 153a may be implemented as a receiver for transmitting a call sound to a user's ears, or a loud speaker for outputting each type of alarm sounds or a play sound of multimedia.

A sound generated from the first audio output unit 153a may be emitted along an assembly gap between structures. In this case, a hole for output of a sound may not be exposed to outside, and thus the appearance of the mobile terminal 100 may be simplified.

The first camera 121a processes image data of still pictures or video acquired by an image capture device in a video capturing mode or an image capturing mode. The processed image frames may be displayed on the display unit 150.

The user input unit is manipulated to input a command for controlling the operation of the mobile terminal 100, and may include a first manipulation unit 131 and a second manipulation unit 132. The first manipulation unit 131 and the second manipulation unit 132 may be referred to as manipulating portions, and may include any type of ones that can be manipulated in a user's tactile manner such as touch, push and scroll.

In drawings, the first manipulation unit 131 is implemented as a touch key. However, the present invention is not limited to this. For instance, the first manipulation unit 131 may be implemented as a mechanical key, or combination of a touch key and a push key.

Content input by the first manipulation unit 131 and/or the second manipulation unit 132 may be set in various manners. For instance, the first manipulation unit 131 may be used to input commands such as menu, home, cancellation and search. And the second manipulation unit 132 may be used to input a command such as controlling a size of a sound output from the first audio output module 153a, or a command such as converting the current mode of the display unit 150 into a touch recognition mode.

The microphone 122 is configured to receive a user's voice, other sound, etc. The microphone 122 may be provided at a plurality of positions, and may be configured to receive a stereo sound.

The interface unit 170 may be generally implemented to interface the mobile terminal 100 with external devices. For example, the interface unit 170 may include at least one of a connection terminal for wired or wireless connection with an earphone, a port for short-range communication (e.g., Infrared ray port (IrDA Port), Bluetooth port, wireless LAN port, etc.), and a power supply terminal for supplying power to the mobile terminal 100. Such interface unit 170 may be implemented as a socket for accommodating therein an external card such as a Subscriber Identity Module (SIM), a User Identity Module (UIM), and a memory card for information storage.

FIG. 2 is a rear perspective view of the mobile terminal 100 of FIG. 1.

Referring to FIG. 2, a second camera 121b may be additionally mounted to the rear surface of the terminal body, i.e., the rear case 102. The second camera 121b faces a direction which is opposite to a direction faced by the first camera 121a (refer to FIG. 1), and may have pixels different from those of the first camera 121a.

For example, the first camera 121a may operate with relatively lower pixels (lower resolution). Thus, the first camera 121a may be useful when a user can capture his or her face and send it to a calling party in a video call mode or the like. On the other hand, the second camera 121b may operate with a relatively higher pixels (higher resolution) such that it can be useful for a user to obtain higher quality pictures for later use. The first camera 121a and the second camera 121b may be installed at the terminal body so as to rotate or pop-up.

A flash 123 and a mirror 124 may be additionally disposed close to the second camera 121b. When capturing an object by using the second camera 121b, the flash 123 provides light to the object. The mirror 124 can cooperate with the second camera 121b to allow a user to photograph himself or herself in a self-portrait mode.

A second audio output unit 153b may be additionally disposed on the rear surface of the terminal body. The second audio output module 153b may implement a stereo function together with the first audio output module 153a (refer to FIG. 1), and may be used for calling in a speaker phone mode.

A broadcast signal receiving antenna (not shown) as well as an antenna for calling may be additionally disposed on the side surface of the terminal body. An antenna, part of a broadcast receiving module may be installed to be retractable into the terminal body.

A power supply unit 190 for supplying power to the mobile terminal 100 is mounted to the terminal body. The power supply unit 190 may be implemented as a battery 191 mounted in the terminal body or detachably mounted to the terminal body. In the drawings, the battery cover 200 is coupled to the rear case 102 so as to cover the battery 191, thereby preventing separation of the battery 191 and protecting the battery 191 from external impacts or foreign materials.

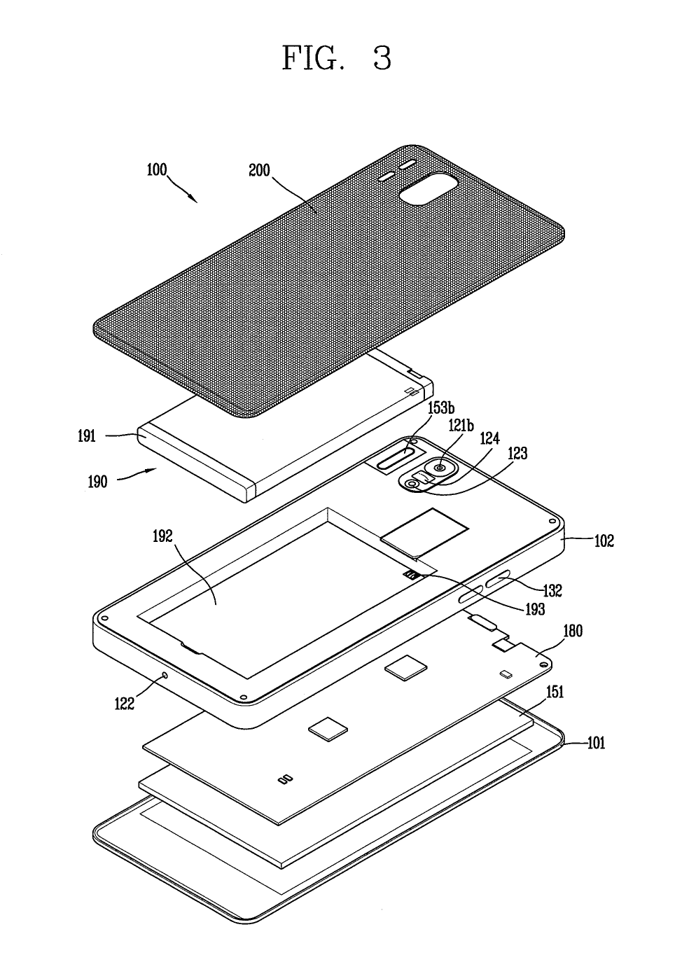

FIG. 3 is a perspective exploded diagram illustrating the power supply unit 190 in FIG. 2.

Referring to FIG. 3, a recessed-type battery accommodation portion 192 is provided in the rear case 102. The battery accommodation portion 192 is formed to the size corresponding to an exterior appearance of a battery in such a manner as to accommodate the battery 191.

A connection terminal 193, which connects to the battery 191, is provided to the battery accommodation portion 192, and the battery 191 connects to a circuit board 180 provided in a mobile terminal body in order to supply electric power to the circuit board 180. The power supply unit 190 is configured from the battery 191, the battery accommodation portion 192, and connection terminal 193.

A battery cover 200 is detachably attached to the rear case 102.

The battery cover 200 is combined with the rear case 102 to cover the battery 191. This prevents the battery 191 from being detached from the battery accommodation portion 192 and protects the battery 191 from external shock and particles.

The battery cover 200, taken as an example of a case with a novel construction to meet a need for various high-quality designs, is described in detail below.

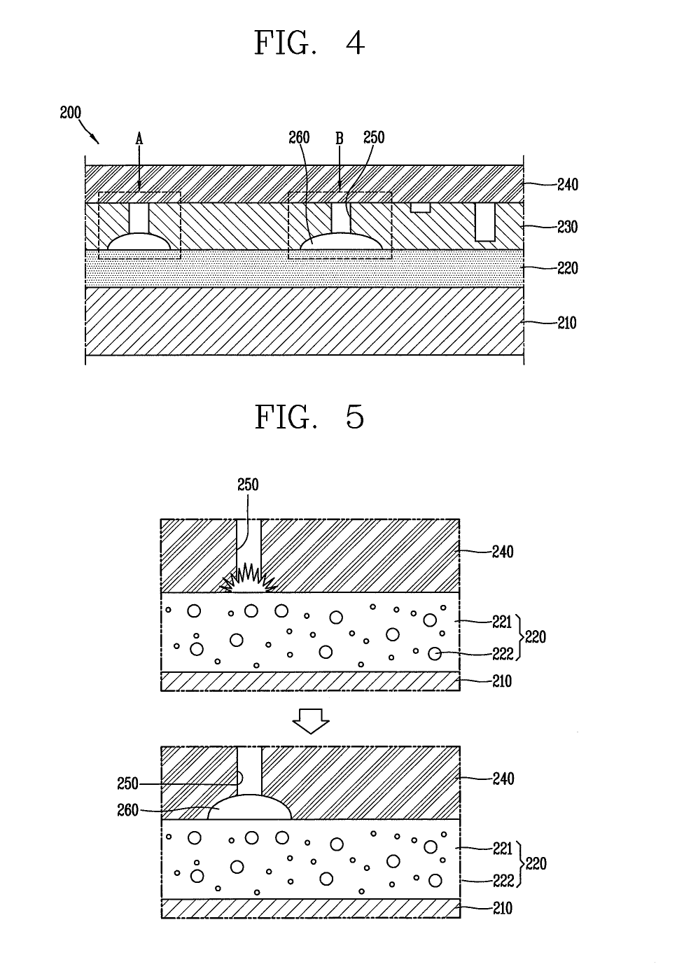

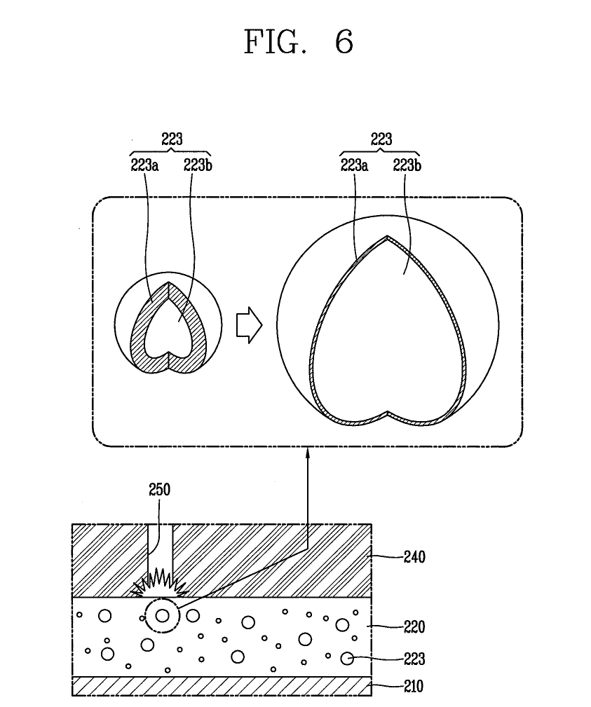

FIG. 4 is a cross-sectional diagram illustrating an example of the battery cover 200 illustrated in FIG. 3. FIGS. 5 and 6 are diagrams illustrating a process of forming a foam portion 260 in parts A and B in FIG. 4, respectively. The construction of the battery cover 200, described below, is applied to a front case 101 and the rear case 102 in the same manner.

Referring to FIG. 4, a base 210 is formed of a rigid material and serves as a foundation on which layers, described below, are deposited. For example, the base 210 is an injection-molded part that is manufactured using injection molding, in which case the battery cover 200 has such a high degree of fluidity that, although complex in internal and external appearance, can be manufactured at a low cost. In addition, the base 210 may have rounded corners or edges.

A color layer 220 and a reflection layer 230 are deposited in this order on the base 210.

The color layer 220 is arranged in such a manner that it covers the base 210 and thus realizes a background color. A heat-sensitive foam material is provided on the color layer 220. The heat-sensitive foam material is formed into the foam portion 260 because when subject to heat, the heat-sensitive foam material foams.

The reflection layer 230 is arranged on the color layer 220. The reflection layer 230 is formed of a material with brightness and thus reflects some of light incident on it. The reflection layer 230 is made from a multi-deposition layer such that a color tone that varies depending on a viewing angle can be realized using light interference.

Multiple etch portions 250 are formed in the reflection layer 230 using laser etching, with the color layer 220 and the reflection layer 230 being deposited on the base 210. At least one or more of the multiple etch portion 250 pierce through the reflection layer 230. The reflection layer 230 may be etched in such a manner that the multiple etch portion 250 have their respective different depths. For example, the reflection layer 230 may be etched in such a manner that the etch portion 250 stays in the reflection layer 230. Alternatively, the reflection layer 230 may be etched in such a manner that the etch portion 250 pierces through the reflection layer 230, thereby exposing the color layer 220.

Heat is generated up to a high temperature during this etching process using the laser etching. If the reflection layer 230 is etched and thus heat is transferred to the color layer 220, the heat-sensitive foam material, provided on the color layer 220, foams due to the heat at the high temperature and thus is formed into the foam portion 260. The foam portion 260 reflects light incident on it such that the battery cover 200 is provided with a texture (or a three-dimensional effect). The foam portion 260 is configured in such a manner as to have a specific pattern in the battery cover 200. On the other hand, the heat-sensitive foam material provided on a region to which a laser light beam is not emitted serves as a filler and thus contributes to enhancing properties of the color layer 220.

The heat-sensitive foam material that is to be formed into the foam portion 260 may be configured as being formed within the color layer 220 itself in a manner that makes chemical foaming possible or be configured as a separate material added to the color layer 220 in a manner that makes physical foaming possible. A process of forming the foam portion 260 in the parts A and B is described in detail below.

Referring to FIG. 5, the heat-sensitive foam material is formed within the color layer 220 as is. For example, if water (distilled water) is added when manufacturing the color layer 220, the heat-sensitivity foam material is formed as illustrated. The heat-sensitivity foam material is a type in which carbon dioxide 222 is trapped within a urethane group material 221 from which the color layer 220 is formed.

When the reflection layer 230 is etched using the laser etching, and the heat is transferred to the color layer 220 exposed to the outside without interference by the laser layer 230, carbon dioxide 222 in the part of the color layer 220 to which the heat is transferred is expanded, thereby forming the foam portion 260 in the shape of a bubble. A size and a shape of the foam portion 260 are controlled by adjusting strength of the laser light beam used in etching, etching time, etching path, and the like.

Referring to FIG. 6, the heat-sensitive foam material is configured such that a separate material is added to the color layer 220 and the physical foaming is made possible. The drawings illustrate that a micro capsule-type heat-sensitive foam material 223 is added to the color layer 220.

Specifically, the heat-sensitive foam material 223 includes a shell 223a, formed of an elastically-transformable material and a gas 223b (for example, hydrocarbon) that fills in the shell 223a. When the heat due to the laser etching is transferred to the heat-sensitive foam material 223, the gas 223b and the shell 223a accommodating the gas 223b are expanded into the foam portion 260.

As described above, when the laser etching is employed and the heat-sensitive foam material sensitive to the heat generated at the time of the laser etching is used, the battery cover 200 can be provided with the texture, and a finer pattern than is obtained in a screen printing can be formed.

Referring back to FIG. 4, the heat up to a high temperature entailed by the etching can make the reflection layer 230 change in form or burned. The reflection layer 230 containing an oxide may be formed in order to endure the heat generated at the time of the formation of the etch portion 250. Specifically, the reflection layer 230 is formed from multi-depositions of a ceramic-based oxide such that it has high heat resistance.

The ceramic-based oxide includes a nitride-based material (for example, TiN, ZrN, Cr2N, CrN, TaN, (Ti, Al)N, (Ti, Zr)N, and others), a carbide-based material (for example, TiC, NC, TaCx, SiC, and others), a carbonitride-based material (for example, TiCxNy, ZrCxNy, (Ti, Al)CxNy, and others), an oxide-based material (for example, TiO2, CrxOy, and others), and an oxinitride-based material (for example, (Ti, Al)OxNy, TiOxNy, and others).

The reflection layer 230 is formed in such a manner that it reacts to the heat generated at the time of the etching of the etch portion 250 and thus covers the foam portion 260. Specifically, if the reflection layer 230 contains an oxide, the oxide is configured in such a manner to cover and thus protect the foam portion 260. The oxide is formed in such a manner as to cover the etch portion 250 on the foam portion 260.

A coating layer 240 making up an external surface of the battery cover 200 is formed on the reflection layer 230. The coating layer 240 is formed of a transparent material and is configured in such a manner as to cover the reflection layer 230 and the etch portion 250 and thus protect the exterior appearance. For example, the coating layer 240 is an ultraviolet light cure layer or a heat cure urethane layer that is formed of a material that is ultraviolet light-cured or is heat-cured.

On the other hand, the color layer 220 is formed of an ultraviolet light cure paint, and a pigment for realizing color is added to such paint. At this time, due to the addition of the color, adhesiveness decreases, or the color layer 220 is not thoroughly cured. Thus, a desirable degree of polymerization is not accomplished, resulting in ablation, a decrease in weather-resistance, discoloration, and others.

To prevent improper curing due to the pigment at the time of the emission of ultraviolet light, an additive containing at least one of aliphatic hydrocarbons, aromatic hydrocarbons and ketones is added to the paint, along with the pigment. The additive is formed in such a manner to improve distribution of the pigment and thus improve adhesion of the color layer 220 to the base 210. In addition, the additive is formed in such a manner as to increase roughness of the color layer 220 and thus improve the adhesion of the color layer 220 to the base 210. In addition, when the color layer 220 is thoroughly cured, the additive evaporates, without influencing subsequent processes.

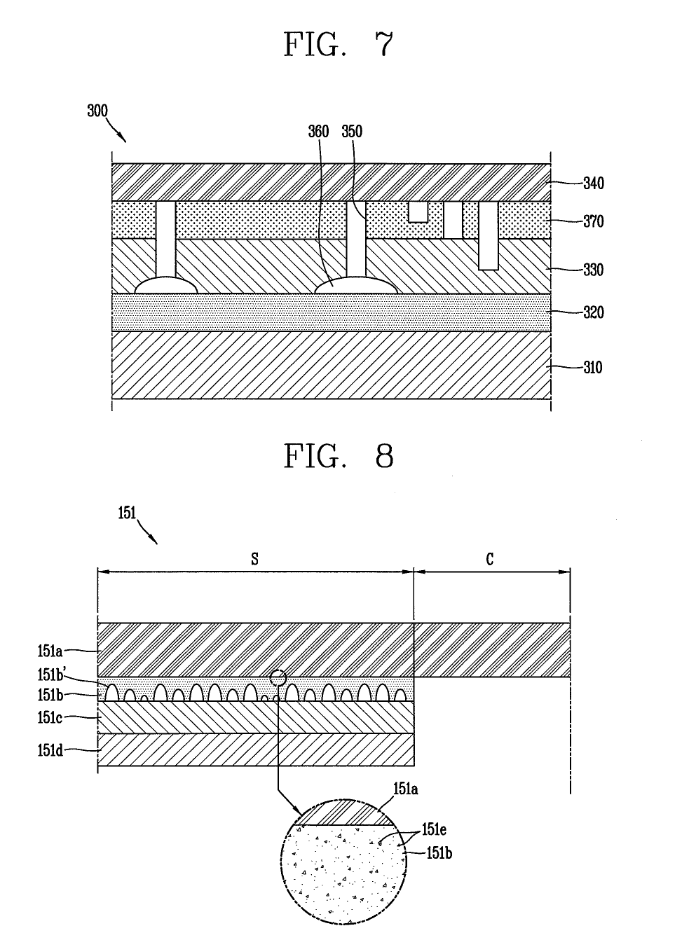

FIG. 7 is a cross-sectional diagram illustrating a battery cover 300 according to another embodiment, which is different from the battery cover 200 illustrated in FIG. 3.

Referring to FIG. 7, a deposition layer 370 is arranged on a reflection layer 330 that is formed from deposition of a metal layer. The deposition layer 370 retains a different color shade from the reflection layer 330. The deposition layer 370 is formed using a physical vapor deposition (PVD) technique, a chemical vapor deposition (CVD) technique, or a smog-type non-conductive vacuum metallization (NCVM) technique.

Multiple etch portions 350 corresponding to the reflection layer 330 are formed on the deposition layer 370. That is, according to the preceding embodiment, the etching is performed after forming the reflection layer 230, but according the present embodiment, the etching is performed after forming the reflection layer 330 and the deposition layer 370.

Some of the multiple etch portions 350 is formed in such a manner as to pierce through the deposition layer 370 in order to expose the reflection layer 330. This is done to realize different color shades. That is, when the etching is performed, or when although the etching is not performed, one part of the deposition layer 370 is etched in such a manner that the reflection layer 330 is not exposed, a metal color of the corresponding part of the deposition layer 370 comes into view. In contrast, when the deposition layer 370 is etched in such a manner that the reflection layer 330 is exposed, a ceramic color of the corresponding part of the reflection layer 330 comes into view. This realizes different color shades.

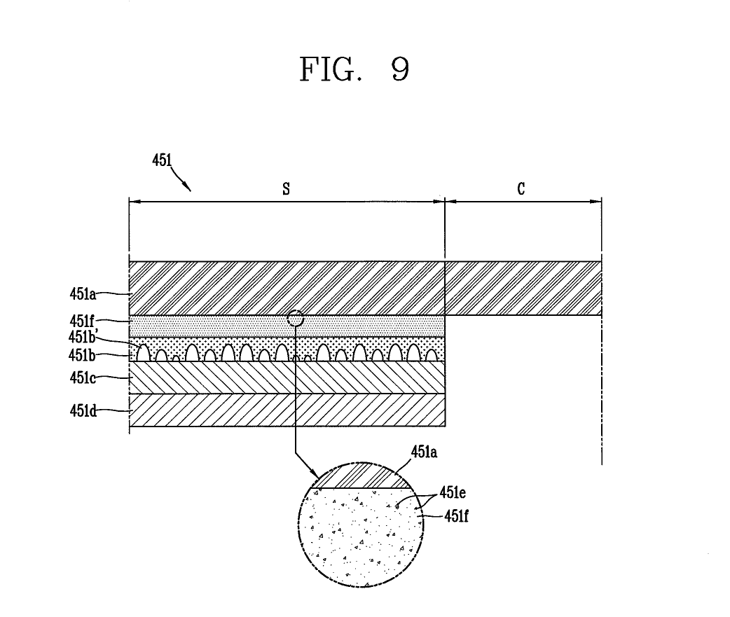

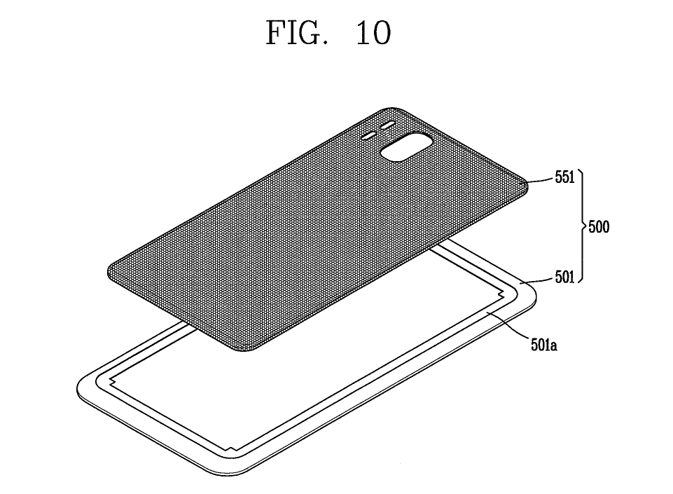

FIGS. 8 and 9 are cross-sectional diagrams, each illustrating an example of a window portion 151 illustrated in FIG. 1.

Referring to FIG. 8, non-transparency processing is performed on an edge region (S) of the window portion 151 and has a layer construction that provides a user with a visual effect of making the edge region (S) be of high grade. As an example, the window portion 151 is formed from an ultraviolet light cure layer 151b, a reflection layer 151c, and a color layer 151d that are deposited in this order on the edge region (S) of a transparent glass 151a.

The ultraviolet light cure layer 151b is arranged in such a manner as to cover a rear surface of the glass 151a corresponding to the edge region (S) and has a pattern portion 151b′ that recesses in a specific shape into one surface of the ultraviolet light cure layer 151b. The pattern portion 151b′ is realized by dispensing ultraviolet light cure liquid onto a rear surface of the glass 151a and pressing a tool in the specific pattern against the ultraviolet light cure liquid. Alternatively, the pattern portion 151b′ is realized by chemically etching an unnecessary part of the ultraviolet light cure liquid dispensed to remove the unnecessary part.

The reflection layer 151c is deposited on one surface of the ultraviolet light cure layer 151b in such a manner as to cover the pattern portion 151b′. The reflection layer 151c is configured such that it reflects at least one part of light incident on it in order for the pattern portion 151b′ to have a three-dimensional effect. The reflection layer 151c is formed of a material with brightness such as a metal material or a ceramic material.

The color layer 151d is formed in such a manner as to cover the reflection layer 151c and thus realize a background color of the window portion 151.

If in such a construction, the ultraviolet light cure layer 151b is formed directly on the glass 151a, adhesion between them is not ensured, resulting in the ultraviolet light cure layer 151b being peeled from the glass 151a. To improve the adhesion of the ultraviolet light cure layer 151b to the glass 151a, a silane additive 151e containing epoxy radical, alkoxysilyl radical, phenolic radical or aromatic ring is added to the ultraviolet light cure layer 151b.

Such silane additive 151e, unlike the silane additive containing a ligand, does not contain a light stabilizer. Therefore, such silane additive 151e is suitable for use in improving the adhesiveness by being added to the ultraviolet light cure layer 151b that reacts to ultraviolet light.

A laser construction illustrated in FIG. 9 is the same as the laser construction described above except that an adhesion layer 451f is arranged between a glass 451a and an ultraviolet light cure layer 451b and a silane additive 451e is added to the adhesion layer 451f. That is, the silane additive 451e as a primer is dispensed onto a rear surface of the glass 451a and thereafter the ultraviolet light cure layer 451b is formed.

The construction of a window portion 151 or 451 described above is realized in a battery cover 500. FIG. 10 is a diagram illustrating an example in which the construction of the window portion 151 or 451 illustrated in FIG. 8 or FIG. 9 is realized in the battery cover 500.

Referring to FIG. 10, the battery cover 500 includes a frame 501 and a window portion 551.

A frame 501 is detachably formed on the rear case 102 and has an accommodation 501a that recesses into the interior of the frame 501. The window portion 551 is mounted into the accommodation 501a and the accommodation 501a is configured in such a manner as to support an edge of the window portion 551.

The window portion 551 is combined with the frame 501 in such a manner that the window portion 551 is on the same level with the battery cover 500. According to the present embodiment, the window portion 551 is arranged in such a manner to take up a large portion of the rear surface of the mobile terminal 100. This configuration enables the rear surface of the mobile terminal 100 to have a three-dimensional image.

According to the present invention with the configuration described above, the heat-sensitive foam material provided on the color layer foams due to the heat generated at the time of the formation of the etch portion, resulting in providing the texture (or the three-dimensional effect). In addition, the deposition layer is deposited on the reflection layer, and some of the multiple etch portions pierce through the deposition layer in such a manner as to expose the reflection layer, realizing various color grades. Accordingly, the case can be provided that meets the need for various high-quality designs.

In addition, the silane additive is added to the ultraviolet light cure layer covering the window portion or to the adhesion layer that attaches the ultraviolet light cure layer to the window portion, resulting in improving the adhesion of the ultraviolet light cure layer to the glass.

The mobile terminal and the method of manufacturing the case provided to the mobile terminal are not limited to the configurations and manners of the embodiments described above, but all of or some of the embodiments may be selectively combined with each other to create various modifications to the embodiments.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising a case that provides an external appearance of the mobile terminal, the case including:
a base;
a color layer covering the base to provide a background color, the color layer including heat-sensitive foam material;
a reflection layer covering the color layer, the reflection layer having multiple etch portions formed therein, at least one or more of the multiple etch portions extending through the reflection layer; and
a foam portion formed from at least a portion of the heat-sensitive foam material to provide a visible texture.

2. The mobile terminal of claim 1, wherein the heat-sensitive foam material is formed of carbon dioxide trapped within a urethane group material.

3. The mobile terminal of claim 2, wherein the heat-sensitive foam material is formed from an addition of water to a urethane group material.

4. The mobile terminal of claim 1, wherein the heat-sensitive foam material includes a shell formed of an elastically-transformable material and a gas that fills the shell, and
wherein the heat-sensitive foam material is configured such that the heat-sensitive foam material foams by an expansion of the gas due to heat generated at the time of the formation of the etch portions.

5. The mobile terminal of claim 1, wherein the reflection layer contains an oxide to endure heat generated at the time of the formation of the etch portion.

6. The mobile terminal of claim 5, wherein the reflection layer is formed from multi-depositions of a ceramic-based oxide.

7. The mobile terminal of claim 1, wherein the reflection layer is formed of material that reacts to the heat generated at the time of etching to cover the foam portion.

8. The mobile terminal of claim 1, wherein the case further comprises a deposition layer that covers the reflection layer, and
wherein one or more additional etch portions are formed in the deposition layer.

9. The mobile terminal of claim 8, wherein at least one of the additional etch portions extends through the deposition layer in order to expose the reflection layer to provide different color grades.

10. The mobile terminal of claim 8, wherein the deposition layer is formed using a physical vapor deposition (PVD) technique, a chemical vapor deposition (CVD) technique, or a smog-type non-conductive vacuum metallization (NCVM) technique.

11. The mobile terminal of claim 1, wherein the case further comprises a coating layer covering the reflection layer and providing the external appearance of the case.

12. The mobile terminal of claim 11, wherein the coating layer is an ultraviolet light cure layer or a heat cure urethane layer.

13. The mobile terminal of claim 1, wherein the color layer is formed of an ultraviolet light cure paint including a pigment and an additive containing at least one selected from the group consisting of aliphatic hydrocarbons and aromatic hydrocarbons.

14. The mobile terminal of claim 13, wherein the additive is dispersed in the ultraviolet light cure paint to provide substantially uniform distribution of the pigment and to increase adhesion between the color layer and the base.

15. The mobile terminal of claim 13, wherein the additive is dispersed in the ultraviolet light cure paint to increase roughness of the color and to increase adhesion between the color layer and the base.

16. The mobile terminal of claim 13, wherein the additive is configured to evaporate once the ultraviolet light cure paint is cured.

17. The mobile terminal of claim 1, wherein the foam portion is formed into a specific pattern in the case.

18. The mobile terminal of claim 1, further comprising a window portion that provides another external appearance of the mobile terminal, the window portion including:
a glass;
an ultraviolet light cure layer covering the glass and having a pattern portion of recesses in one surface of the ultraviolet light cure layer;
a reflection layer on one surface of the ultraviolet light cure layer, the reflection layer covering the pattern portion and configured to reflect at least one part of light incident thereon to provide a three-dimensional effect;
a color layer covering the reflection layer and providing a background color of the window portion; and
a silane additive containing one selected from the group consisting of epoxy radical, alkoxysilyl radical, phenolic radical, and aromatic ring that increases adhesion of the ultraviolet light cure layer to the glass.

19. The mobile terminal of claim 18, wherein the silane additive is added to the ultraviolet light cure layer or is added to an adhesion layer arranged between the window portion and the ultraviolet light cure layer.

20. The mobile terminal of claim 1, wherein the base is a synthetic resin material.

21. A method of manufacturing a case providing an external appearance of a mobile terminal, comprising:
providing a base formed of a synthetic resin material;
providing a color layer including a heat-sensitive type foam material on the base;
providing a reflection layer having a predetermined thickness on the color layer; and
etching the reflection layer such that the heat-sensitive type foam material foams due to heat generated at the time of the etching to provide a visible texture.
